(19) United States
(12) Patent Application Publication
(10) Pub. No.: US 2018/0066374 A1
(43) Pub. Date: Mar. 8, 2018

(54) ANODIZATION AND POLISH SURFACE TREATMENT FOR HIGH GLOSS DEEP BLACK FINISH

(71) Applicant: Apple Inc., Cupertino, CA (US)

(72) Inventors: Duy P. Le, Santa Clara, CA (US); Masashige Tatebe, Kakogawa-shi (JP); Jody R. Akana, San Francisco, CA (US); Jeremy D. Bataillou, San Francisco, CA (US); Shota Aoyagi, San Francisco, CA (US); Richard Hung Minh Dinh, Saratoga, CA (US); Ricky C. Lee, Arcadia, CA (US); Thomas Johannessen, San Jose, CA (US); Benjamin S. Bustle, Cupertino, CA (US); Rasamy Phouthavong, San Jose, CA (US); Zechariah D. Feinberg, San Francisco, CA (US); Tiffany Hu, Campbell, CA (US); Dandan Wan, Shanghai (CN); Chuanyou Su, Shenzhen (CN); Phillip W. Hum, Shanghai (CN); Michael P. Coleman, San Francisco, CA (US); Jong Kong Lee, Suzou (CN)

(21) Appl. No.: 15/615,815

(22) Filed: Jun. 6, 2017

(30) Foreign Application Priority Data
Sep. 6, 2016 (CN) PCT/CN2016/098174

(51) Int. Cl. C25D 11/24; C22F 1/04; H04M 1/02; H04M 1/18

(52) U.S. Cl. CPC C25D 11/243; H04M 1/185; H04M 1/026; C22F 1/04

(57) ABSTRACT

A high gloss deep black housing for a handheld electronic device is disclosed having either a textured or a mirror finish. Methods for preparing a housing having the high gloss deep black finish are also disclosed, including housings for mobile phones.

### CROSS-REFERENCE TO RELATED APPLICATION(S)

This application claims the benefit under 35 U.S.C. §119 and 37 C.F.R. §1.55 to PCT Application No. PCT/CN2016/098174, filed Sep. 6, 2016 and titled “Anodization and Polish Surface Treatment for High Gloss Deep Black Finish,” the disclosure of which is hereby incorporated herein by reference in its entirety.

### FIELD

The described embodiments relate generally to housings for use in handheld electronic devices. More particularly, the present embodiments relate to housings having a high gloss deep black finish for use in handheld electronic devices.

### BACKGROUND

Handheld electronic devices, such as mobile phones, are becoming smaller, lighter and more powerful. The design challenge of making these devices with these parameters often requires new or modified designs, materials and components. One such challenge is uniformity of appearance, as smaller and thinner materials and components will often be more liable for coating imperfections, induced blemishes due to variations in thermal heating, non-uniform coloring due to inconsistent polishing, and the like.

Handheld electronic devices are also held to a high standard of reliability, particularly when it comes to the durability of the exterior surface. These devices are typically under constant use, and need to maintain a uniform surface quality and tactile feel. The imperfections associated with smaller, lighter and more powerful devices, therefore, can result in a significant loss of reliability and durability to the device.

### SUMMARY

Embodiments herein include a housing for a handheld electronic device, for example a mobile phone, having an exterior surface with a mirror finish, the mirror finish having an average surface roughness (Ra) of from 10 nm to 30 nm. In some aspects, the polished exterior surface of the housing abuts an anodization layer having an average pore size diameter of 10 nm to 40 nm. The anodization layer having a dye uniformly distributed to a depth of at least 7 μm, and more typically from 8 μm to 10 μm, into the anodization layer. In some aspects, the dyed anodization layer is further coated with an oleophobic layer.

Embodiments herein also include methods for manufacturing housings for handheld electronic devices having a deep black finish. Methods include polishing an aluminum alloy substrate for a handheld electronic device to a near mirror finish, anodizing the housing such that an anodization layer is formed having an average diameter pore size of 10 to 40 nm, dyeing the anodized housing such that the dye is uniformly distributed into the anodization layer, and polishing the dyed anodization layer to define a smooth, high gloss deep black surface. In some aspects, the dyeing is performed in a dye bath heated to approximately 50° C. to 55° C., and the housing dyed in the bath for between 5 and 20 minutes. In other aspects, an oleophobic coating is applied to the finished housing, which can be accomplished by, for example, PVD coating.

Embodiments can also include methods for manufacturing housings for handheld electronic devices having a matted black finish. Methods include media blasting an exterior surface of a housing, the housing composed of an aluminum alloy substrate, with zirconia, or other like particles, anodizing the housing such that a textured anodization layer is formed abutting the blasted aluminum alloy substrate, and dyeing the anodized housing such that the dye is uniformly distributed into the textured anodization layer. In some aspects, the dyeing is performed in a dye bath heated to approximately 20° C. to 45° C., and the housing dyed in the bath for between 3 and 10 minutes. In other aspects, an oleophobic coating is applied to the finished housing, which can be accomplished by, for example, PVD coating.

In another embodiment, a handheld electronic device that includes a high gloss deep black housing is disclosed. The exterior surface of the housing has a mirror finish. The interior surface of the housing is configured to receive a plurality of electronic components. A cover glass is coupled to the housing. In some aspects, the housing is composed of an aluminum alloy substrate and abuts an anodization layer exhibiting average pore diameter sizes of 10 nm to 40 nm. A black dye is uniformly distributed in the anodization layer to a depth of at least 7 μm.

Other features and advantages of the present disclosure will be apparent from the accompanying drawings and from the detailed description that follows below.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an electronic device having a housing in accordance with embodiments herein;

FIG. 2 is a partial cross-sectional schematic view of a housing having an interior and exterior surface in accordance with embodiments herein;

FIG. 3A shows a housing undergoing anodization in accordance with embodiments herein;

FIG. 3B shows a housing in a black dye bath in accordance with embodiments herein;

FIG. 4 is a cross-sectional view of a portion of a dye saturated anodization layer in accordance with embodiments herein;

FIG. 5A is a cross-sectional schematic view of a high gloss deep black polished housing surface in accordance with embodiments herein;

FIG. 5B is a textured polished housing surface in accordance with embodiments herein;

FIG. 5C is a schematic cross-sectional view along line A-A in FIG. 1 of a portion of a high gloss deep black housing surface further including an oleophobic coating;

FIG. 6A is a flow diagram for preparing a housing surface having a high gloss deep black finish in accordance with embodiments herein; and

FIG. 6B is a flow diagram for preparing a housing surface having a textured finish in accordance with embodiments herein.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, they are intended to cover alternatives, modifications, and equivalents as can be included within the spirit and scope of the described embodiments as defined by the appended claims.

The following disclosure relates to a housing for a handheld electronic device exhibiting a high gloss, deep black finish. The housing surrounds and supports the electronic components of the handheld electronic device, and may be either smooth or textured to the touch. A transparent top layer is captured by the housing, and can be formed of any number of durable and strong materials, for example, polished glass, plastic or sapphire.

Housings in accordance with embodiments herein have an exterior surface of uniform deep black color, i.e., the black color has a Lightness (L*) value of less than 30, and more typically less than 25, and in some cases less than 20 (as measured using the Commission Internationale de l'Eclairage (CIE) standard, where lightness of the sample is compared to a standard to provide a ΔL*). The black color is uniform over the entire exterior surface, even after the surface is polished to provide a high gloss finish. In some embodiments, the high gloss finish is a mirror finish, where the surface roughness of the finish is between about 10 to about 30 nm, and more typically between about 13 nm to about 19 nm (as measured peak-to-valley).

Alternative housings in accordance with embodiments herein have an exterior surface of textured, deep black color. The textured black color is uniform and provides an average surface roughness of from about 8 μm to about 12 μm, and in some embodiments about 10 μm. In other embodiments, the average surface roughness is 10 μm. The texture from the surface roughening, i.e., peak to valley, is typically up to 7 μm, and more typically, up to 5 μm, and often between 3 and 5 μm. As in the previous embodiment, some or all of the textured housing can be polished to provide a high gloss, textured finish.

Housings for handheld electronic devices are formed from aluminum alloy substrates that have been formed into an appropriate shape for supporting and surrounding the various components necessary for the handheld electronic device. The housing also provides openings into which switches, connectors, displays, and the like can be accommodated. Aluminum alloy substrates are polished to a near mirror finish, and anodized in an anodization bath to provide an appropriate anodization layer.

Embodiments herein typically include anodization layers having an average diameter pore size of from about 10 nm to about 40 nm, and more typically from 15 nm to 35 nm, and most typically from 20 nm to 30 nm. In order to form the deep black housing, an anodized housing can be placed in a black dye bath for 5 to 20 minutes, and more typically 15 to 20 minutes. Although dye bath conditions may vary, a typical temperature for dyeing is 50° C. to 55° C., and a typical dye concentration is 8 g/L to 12 g/L, and more typically 10 g/L. Once dyed, the housing is rinsed and polished to provide a high gloss finish. Polishing procedures in accordance with embodiments herein remove from about 4 μm+/−2 μm of the dyed anodization layer. Generally, the black dye is uniformly distributed in a set of pores in the anodization layer to a depth of at least 3 μm, and more typically at least 5 μm, and still more typically at least 7 μm, and in some cases between 8 and 10 μm, thereby ensuring that the overall color remains constant, even after the polishing operation removes some of the anodization layer. That is, the anodization layer is dyed to a sufficient depth that removing material in the polishing operation does not affect or perceptibly alter the color of the housing.

The look of the housing is smooth and high gloss, and is a uniform deep black color. In some embodiments, an oleophobic coating is applied to the polished surface to seal the dyed anodization layer, and to provide additional properties such as chemical resistance, resistance to fingerprint and other debris transfer, and the like.

Still other embodiments take the form of another method for creating a housing having a textured, deep black finish. In such embodiments, the aluminum alloy substrate of the housing is blasted, sanded, abraded, or otherwise treated with zirconia in order to establish an average surface roughness of between 8 μm and 12 μm, and more typically 10 μm. In some aspects, other media beyond zirconia may be utilized to establish the surface roughness, as long as the media is harder than the aluminum alloy substrate, e.g., other ceramic-based beads, silicon carbide, etc. Typical peak to valley texturing that results from the media blasting is up to 7 μm, and more typically up to 5 μm, and often times between 3 and 5 μm. The textured surface allows for more efficient anodization and corresponding dyeing. Further, a housing treated in this manner may exhibit a more uniformly textured deep black finish in which defects to the housing itself are hidden from view, insofar as the texture diffuses reflected light and thereby reduces the visibility of surface imperfections.

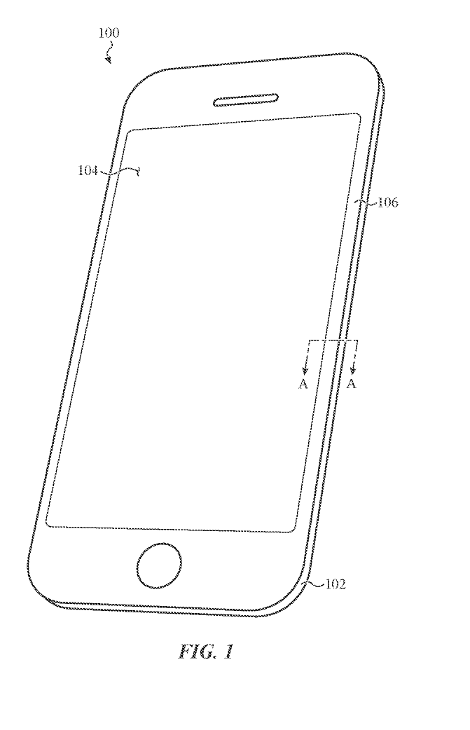

These and other embodiments are discussed below with reference to FIGS. 1-6. However, those skilled in the art will readily appreciate that the detailed description given herein with respect to these Figures is for explanatory purposes only and should not be construed as limiting.

FIG. 1 illustrates one embodiment of a handheld electronic device 100 in accordance with embodiments herein. In this embodiment, the view is of a mobile phone having a housing 102 having a high gloss deep black finish. The mobile phone housing is textured and/or colored in accordance with embodiments herein. The mobile phone includes a cover glass 104 with a bezel 106 about all of its edge, where the bezel is coupleable to the housing in a manner that secures the cover glass. Cover glass 104 can be formed of suitable transparent material, for example, transparent glass, transparent plastic or polymer, or transparent crystalline materials such as sapphire or sapphire glass. Although a mobile phone is illustrated, it should be appreciated that embodiments may include any housing of any electronic device, or any other suitable metal (or metallic) surface, as appropriate.

The housing in FIG. 1 is made from an aluminum alloy and exhibits a high gloss deep black finish. The housing structure can be formed by any number of methodologies, including forging, molding, machining or otherwise processing it into a desired shape. In the present embodiment, the housing has been configured to enclose the internal components of a mobile phone, including the structural and electronic components. The housing structure typically includes a flat portion surrounded by curved side walls. Note that the curvature on the side walls can be varied. In some embodiments, the side walls can be substantially flat and extended from the flat portion of the housing via a specified radius of curvature. Housings embodiments herein can have varied thickness, including a maximum thickness of 10 mm, and more typically a maximum thickness of 8 mm, and in some aspects a maximum thickness of 5 mm or 3 mm. In some embodiments, the housing has a hardness of at least 125 Hv, as measured on a Vickers hardness scale.

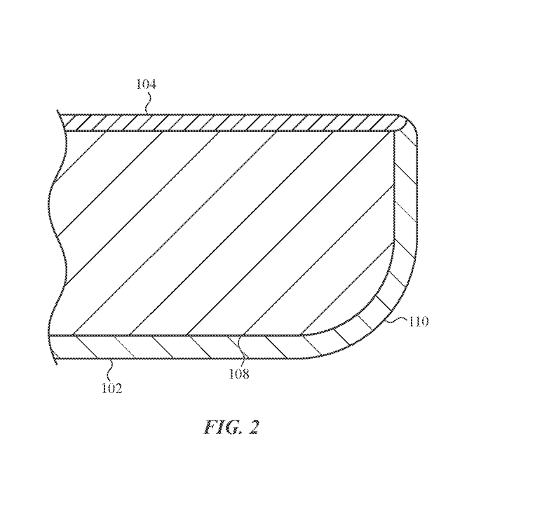

FIG. 2 is a cross-sectional schematic along line A-A of FIG. 1. A housing 102, in accordance with embodiments herein, is coupled to a cover glass 104. The housing has an internal 108 and external surface 110, where the internal surface 108 supports and surrounds various structural and electronic components of the mobile phone. Although both surfaces of the housing can be anodized and dyed, see below, only the external surface 110 is typically polished to a finish in accordance with embodiments herein.

In one embodiment, the external surface 110 of the aluminum alloy substrate housing is polished to a near mirror or mirror like surface. Polishing is via a flat polish or other like method to provide an external surface that does not show a tangency break or cutter marks. Note that additional 3D polishing is utilized where necessary to polish around openings and protrusions. It is also envisioned that only some portion of the exterior surface be polished to a near mirror or mirror like surface, although typical embodiments include polishing of the entire exterior surface.

In an alternative embodiment, the external surface of the aluminum alloy substrate is media blasted with zirconia powder or beads to exhibit a roughened surface (as opposed to being polished). The roughened surface typically shows an average Ra of from about 8 to 12 μm, and more typically an average Ra of about 10 μm, and most typically an average Ra of 10 μm. The blasted surface shows a textured finish, where a part's difference between any one peak and any one valley on a housing's surface is, up to 7 μm, and more typically, up to 5 μm, and most typically between 3 to 5 μm.

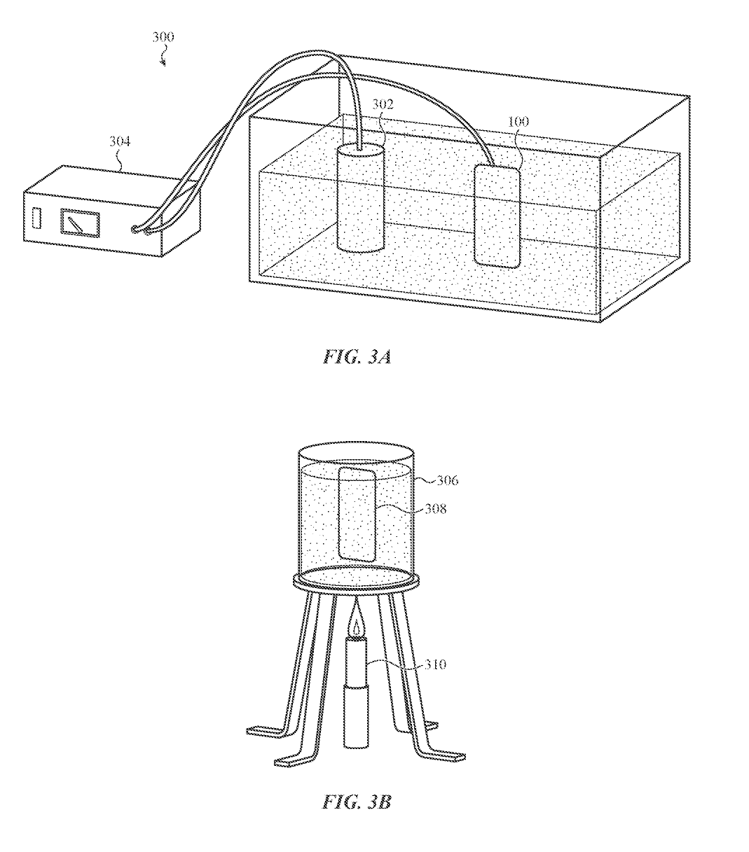

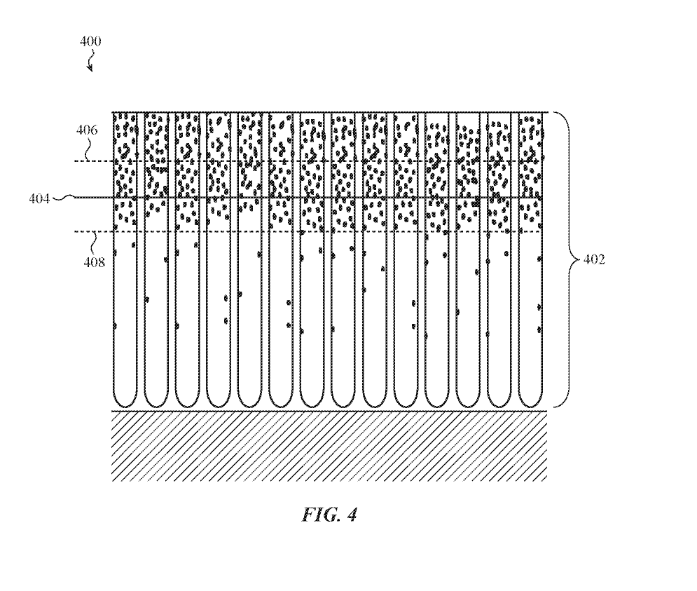

FIG. 3A shows an illustrative anodization bath 300 in accordance with embodiments herein. A housing 100 in accordance with embodiments herein is placed in an anodization bath as the anode, for controlled anodization layer growth on the housing surface. FIG. 3A also shows a cathode 302 and power supply 304, where the anodization can be run at 1-1.5 A/dm² for 30-45 minutes in an electrolyte solution, for example. Where the starting aluminum alloy substrate is first polished to a near mirror finish, the housing is anodized in the bath until an approximately 16 μm to 25 μm, anodization layer is formed. The anodization layer abuts the polished, exterior surface of the aluminum alloy substrate. However, within any one part, controlled anodization is maintained to keep the layer on that part substantially uniform, so for example, a part has a uniform anodization layer of 18 μm across its entire exterior surface. Anodization layers can be formed of aluminum oxide, or other like oxide, and should exhibit a 10 nm to 40 nm average diameter pore size, and more typically 15 nm to 35 nm, and most typically from 20 nm to 30 nm average diameter pore size.

Alternatively, where the starting aluminum alloy substrate is textured via media blasting, the housing is anodized in the bath until an approximate 16 μm to 20 μm anodization layer is formed. As above, within any one part, controlled anodization is maintained to keep the layer on that part substantially uniform. Also as above, the anodization layer can be formed of aluminum oxide, or other like oxide, and has a 10 nm to 40 nm average diameter pore size, and in some cases a 15 nm to 35 nm average pore size, and in other cases 20 nm to 30 nm average pore size. Anodization parameters are often more easily attained for the textured housing, as the roughened surface can act as an initiation or nucleation site for the anodization reaction.

FIG. 3B shows a schematic of a black dye bath 306 in accordance with embodiments herein. Anodized housings 308 are rinsed and moved to a heated dye bath. The dye bath is prepared with black dye, for example 8 g/L to 12 g/L, and heated to an appropriate temperature to penetrate the anodized layer (the layer having an average diameter pore size of 10 nm-40 nm). In one embodiment, where the housing has flat or non-matted anodization layer, the dye bath is heated from between 50° C. to 55° C., and more typically 55° C., by an appropriate heating source 310. Once heated to an appropriate bath temperature, the housing embodiments are submerged in the black dye for a period of from about 5 to 20 minutes, and more typically, from about 15 to 20 minutes. Over saturation in the dye bath can lead to anodization layer chipping or other like damage. Dye is uniformly distributed in the porous anodization layer to a depth (from the surface) of at least 3 μm, and typically at least 5 μm, and more typically at least 7 μm, and in some embodiments from 8 to 10 μm. The uniform distribution of the dye imparts the deep black color to the anodization layer. Typically the dye flows into the pores (10-40 nm) of the anodized surface. In some embodiments, the black dye may also contain a stabilizer to control the dye bath pH.

Dyeing of the housing showing the matted finish can also performed in a heated dye bath. The dye bath is prepared with black dye, for example 8 g/L to 12 g/L, and more typically 10 g/L, and heated to an appropriate temperature to penetrate the anodized layer (the layer having an average diameter pore size of 10 nm-40 nm). In the case of the housing with a textured finish, the bath is heated to approximately 20° C. to 45° C. by an appropriate heating source 310. Once heated to an appropriate bath temperature, the textured housing embodiments are submerged in the black dye for a period of from about 3 to 10 minutes. Over saturation in the dye bath can lead to anodization layer chipping or other like damage. Dye is uniformly distributed in the porous anodization layer to a depth (from the surface) of at least 3 μm, and typically at least 5 μm, and more typically at least 7 μm, and in some embodiments from 8 to 10 μm. The uniform distribution of the dye imparts the deep black color to the anodization layer. Typically the dye flows into the pores (10-40 nm) of the textured anodized surface. In some embodiments, the black dye may also contain a stabilizer to control the dye bath pH.

For purposes herein, stable dye incorporation into the anodization layer, with appropriate pore size, should be to a sufficient depth to allow polishing of the anodization layer so that removal of the layer does not affect the deep black color of the housing surface. For example, if 4 μm of anodization layer is to be removed by polishing, the dye is uniformly distributed to a depth of at least 5 μm.

FIG. 4 shows a representative schematic cross-sectional view of a housing surface 400 having an anodization layer 402 dyed deep black in accordance with the embodiment herein. A second polish is applied to the dyed anodization layer. Polish of the dyed anodization layer results in a smooth high gloss look with a deep black color. Embodiments herein include a polish that removes from about 4 μm+/−2 μm of the dyed anodization layer (shown as solid black line, 404). A polish that removes too little of the dyed anodized layer can result in a low gloss finish, or an “orange peel” finish (shown as dashed line, 406). As shown in FIG. 4, polishing removal of two or less μm from the dyed anodization layer can result in this deleterious look. However, removal of too much dyed anodization layer may conversely result in a variable color on the surface housing, as the black dye has not uniformly distributed to the depth beyond which the layer has been removed (shown as dashed line, 408). FIG. 4, dashed line 408, illustrates that polishing of the layer to the extent that 10 μm has been removed, would likely result in an inconsistent amount of dye being exposed on the surface of the housing, thus showing a non-uniform coloration (discoloration).

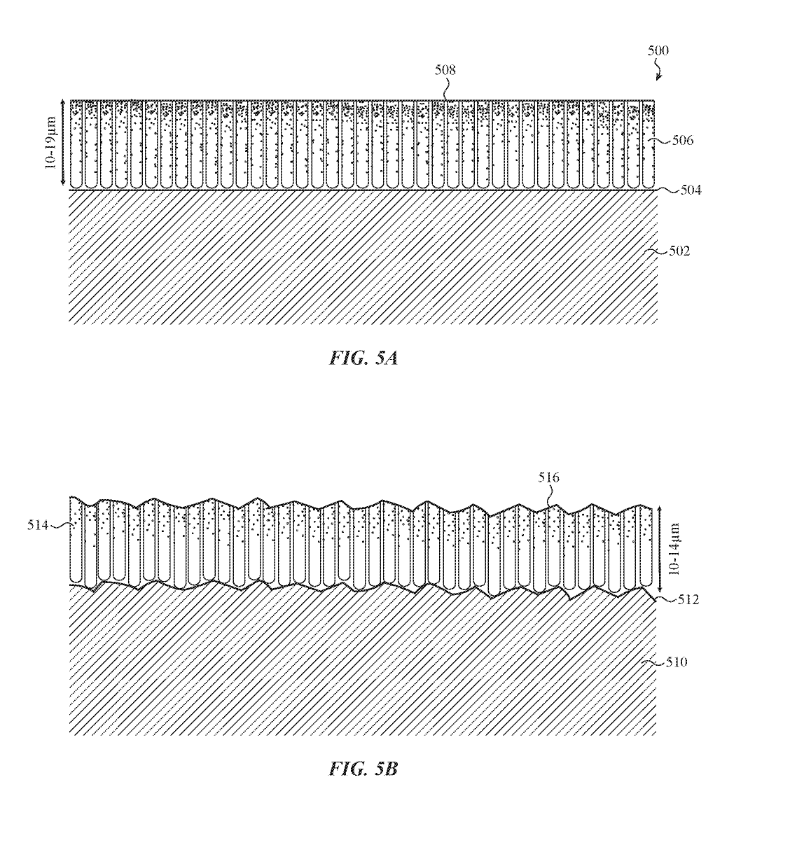

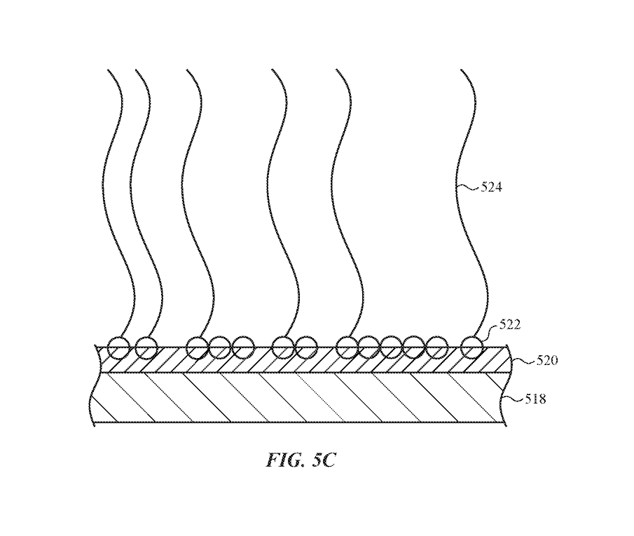

FIG. 5A is another illustrative cross sectional view of a housing having a high gloss deep black finish 500. The housing 500 is composed of an aluminum alloy substrate, typically having a hardness of at least 125 Hv 502. The surface of the aluminum alloy substrate is polished to a near mirror finish 504. The black dye anodization layer 506, abutting the polished substrate surface, is typically about 10 to 19 μm in thickness, having been sufficiently polished to provide a high gloss and deep black finish.

FIG. 5B provides an alternative illustrative cross sectional view of the aluminum alloy substrate, this time with a textured surface 512. In this embodiment, the aluminum alloy substrate housing has been zirconia, or other like material, blasted to provide a roughened surface, i.e., textured look 512. A final, after polish, dyed anodization layer 514 abuts the textured surface, the dyed anodization layer having a thickness of from about 10 μm to 14 μm. The texture of the aluminum alloy substrate is exhibited in the anodization layer 516. Embodiments herein show up to a 7 μm peak to valley texture, or more typically up to a 5 μm peak to valley texture, and in some cases, a 3 to 5 μm peak to valley texture. The polished anodized layer shown in FIG. 5A and/or FIG. 5B can be further treated with an oleophobic coating, as is shown in FIG. 5C.

FIG. 5C is an exploded, cross-sectional view of one such oleophobic coating in accordance with embodiments herein. In FIG. 5C, the dyed anodization layer 518 is further treated with application of an adhesive layer 520, for example, SiO₂ and coupled via a coupling group 522 to a fluoropolymer 524 for an oleophobic coat. Housings with a mirror finish (not textured) have a surface roughness from about 10 nm to 30 nm, and more typically 13 nm to 19 nm. Textured housings have a high gloss and deep black finish as well, but do not exhibit the mirror finish. However, textured housings can hide surface defects found in the aluminum or aluminum-based alloy, or blemishes introduced by imprecise polishing or machining, that would be apparent in a mirror like finish.

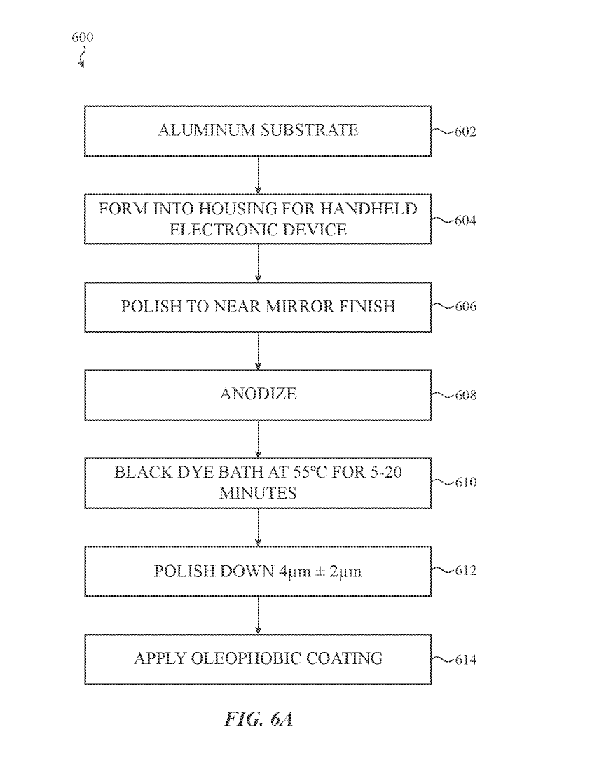

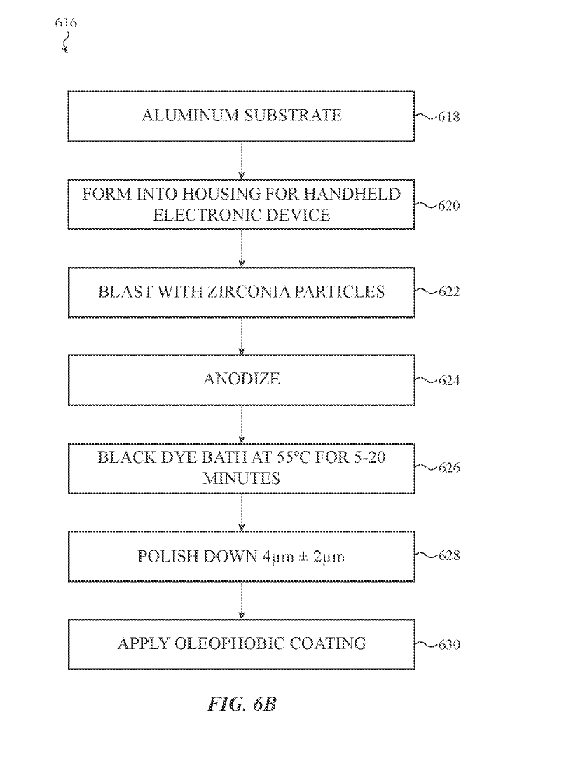

Embodiments herein also include methods for manufacturing housings with high gloss deep black finishes. In FIG. 6A, one such embodiment is show 600, where an aluminum alloy substrate is obtained in appropriate dimensions to form a handheld electronic device of interest 602. The aluminum alloy substrate is forged, molded, or machined, or other like process, into an appropriate shape for a desired handheld electronic device 604. Housings have an interior and exterior surface, where the interior surface provides support and surrounds the internal components of the handheld electronic device. The exterior surface of the aluminum ally substrate is polished using a flat or other like polish to present a near mirror finish to the surface 606. The polished aluminum alloy substrate is placed in an anodization bath for controlled anodization layer growth, with a uniform layer abutting the surface and being formed across the entirety of at least the exterior surface of the housing 608 (note that anodization can be limited to the exterior surface, or be formed on both surfaces). Anodization layer thickness can vary between housings, but is typically between 16 μm and 25 μm, so for example, a housing having a uniform anodization layer across the surface of 18 μm in thickness. Average anodization pore size diameters are between about 10 nm and about 40 nm, but can also be 15 nm to 35 nm, and 20 nm to 30 nm. After one or more washings, the anodized housing is placed in a heated black dye bath 610. Dye in the bath is typically on the order of 10 g/L, although other dye concentrations can be used. The dye bath can be heated to various temperatures, although 50° C. to 55° C. is typical, and 55° C. is more typical. Anodized housings are allowed to saturate with the black dye for between 5 and 20 minutes, and more typically between about 15 to 20 minutes. Over dyeing the housing in the dye bath can result in anodization chipping or other deleterious events. Once dyed, the dyed anodization layer should have uniformly distributed black dye that extends down into the anodization layer for between at least 3 μm, and more typically at least 5 μm, and often to at least 7 μm in depth. In some cases, the dye is allowed to uniformly distribute to a depth of between 8 μm to 10 μm. Polishing, typically by flat polish, is accomplished in the exterior surface of the housing to provide a high gloss finish 612. The polishing typically removes from about 4 μm+/−2 μm of the dyed anodization layer, the resultant finish is uniformly dyed across the entirety of the surface. Polishing of the dyed anodization layer should remove enough of the layer to provide a high gloss finish, but not so much that the part shows discoloration. Having dye distribute to the unexpected depths as disclosed herein provides for the capacity to polish to a high gloss and still maintain a deep black coloration. In some embodiments, an oleophobic coating is applied to the polished layer to provide protection to the mirror like finish, where fingerprints or chemical damage would present a significant obstacle 614.

In FIG. 6B, a method for manufacturing housings with a textured, deep black finish is provided 616. In FIG. 6B, an aluminum or aluminum-based substrate is obtained in appropriate dimensions to form a handheld electronic device of interest 618. The aluminum alloy substrate is forged, molded, or machined, or other like process, into an appropriate shape for a desired handheld electronic device 620. Housings have an interior and exterior surface, where the interior surface provides support and surrounds the internal components of the handheld electronic device. The exterior surface is media blasted with a zirconia powder or bead, or other like material, to provide an average surface roughness of 8 to 12 μm, and more typically about 10 μm 622. Texturing of the surface, i.e., peak to valley of the blasted surface, is less than about 7 μm, and typically less than about 5 μm, and most typically between 3 and 5 μm. The textured surface provides an excellent initiation point for anodization layer growth. Anodization layer thickness can vary between housings, but is typically between 16 μm and 20 μm, so for example, a housing having a uniform anodization layer of 17 μm in thickness 624. Average anodization pore size diameters are between about 10 nm and about 40 nm, 15 nm to 35 nm, or 20 nm to 30 nm. After one or more washings, the anodized housing is placed in a heated black dye bath 626. Dye in the bath is typically on the order of 10 g/L, although other like dye concentrations can be used. The dye bath can be heated to various temperatures, although 50° C. to 55° C. is typical, and 55° C. more typical. Anodized housings are in the black dye bath for between 5 and 20 minutes, and more typically between about 15 to 20 minutes. Over dyeing the housing in the dye bath can result in anodization chipping or other deleterious events. Once dyed, the dyed anodization layer should have uniformly distributed black dye that extends down into the anodization layer as discussed above. Optionally, polishing, typically by flat polish, is accomplished in the exterior surface of the housing to provide a high gloss, but textured finish 628. Polishing avoids removal of the textured finish. The polishing typically removes from about 4 μm+/−2 μm of the dyed anodization layer, the resultant finish is uniformly dyed across the entirety of the surface. Polishing of the dyed anodization layer should remove enough of the layer to provide a high gloss finish, but not so much that the part shows discoloration. Having dye distribute to the unexpected depths as disclosed herein provides for the capacity to polish to a high gloss and still maintain a deep black coloration. In some embodiments, an oleophobic coating is applied to the polished layer to provide protection of the textured finish, where fingerprints or chemical damage would present a significant obstacle 630.

### Examples

Housing embodiments in accordance with the present disclosure were prepared. An aluminum-based alloy substrate was molded into a mobile phone housing and anodized in accordance with the present embodiments. The anodized housing was then placed in a black dye bath having 10 g/L black dye and heated to 55° C. Housings were dyed either for 1 minute, 5 minutes, 10 minutes, 15 minutes, 20 minutes or 30 minutes and tested for anodization layer chipping yield. Damage due to dyeing the housing was found to be minimal when the housing was dyed for between 1 and 20 minutes, but showed significant damage when the part was dyed for 30 minutes (40% anodized chipping fall out). It is therefore likely that extended dyeing times results in corrosion and damage.

Dyed housings having little or no anodized chipping, were then flat polished to identify the uniformity and stability of the deep black look after polishing. Polish procedures were performed that removed 0 to 4.5 μm of material. Lightness and color (L, a, b=lightness, red/green, and yellow/blue) were then tested and compared to conventionally prepared housings. Housing embodiments as described herein showed uniform lightness and color, even where up to 4.5 μm were polished off of the dyed anodization layer. These housings showed the high gloss and deep black finish described herein. Conversely, conventional housings, post processed with polishing of from 0 to 4.5 μm, showed significant lightness change (showing discoloration) starting at 2 μm, and significant color variation, also starting at about 2 μm.

Additional dye testing was performed on housing in conformance with embodiments herein, where housings were tested for lightness (L) and color (a and b) after the housing was anodized, as well as after the housing was anodized and polished, with 2 to 5 μm material removed. Housings were dyed under the same conditions as above for 1 minute, 5 minutes, 10 minutes, 15 minutes, 20 minutes and 30 minutes. Comparisons were then made for each dye time.

Housings having been dyed for 1 minute showed significant variation between the after anodization and after polishing housings, indicating that a one minute dye is insufficient to allow for polishing to a uniform high gloss deep black finish. However, housings that were dyed for 5-30 minutes provided consistent values that indicate deep dye penetration, beyond the 5 μm depth. However, as discussed above, dye times above 20 minutes increases the likelihood that the anodization layer may more likely damage, so dye times between 5 and 20 minutes show excellent utility.

The present example shows the significant and surprisingly improved utility of housings prepared using the embodiments described herein. In particular, using a dye time of 5 to 20 minutes at 55° C. with 10 g/L dye allows for polish removal of more than 2 μm dyed anodization layer and results in a high gloss deep black finish.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A housing for a handheld electronic device comprising:
an aluminum alloy substrate having a surface;
an external anodization layer abutting the aluminum alloy surface; and
a dye within the external anodization layer; wherein
the external anodization layer has a surface roughness (Ra) of from 10 nm to 30 nm;
the external anodization layer defines a set of pores, each of the set of pores having an average pore diameter size from 10 nm to 40 nm; and
the dye is substantially uniformly distributed within the set of pores to a depth of at least 5 μm.

2. The housing of claim 1, wherein the surface of the aluminum alloy substrate has a near mirror finish.

3. The housing of claim 1, wherein the surface of the aluminum alloy substrate is textured with a peak-to-valley difference from 3 μm to 5 μm.

4. The housing of claim 1, wherein the external anodization layer has a thickness of from 10 μm to 19 μm.

5. The housing of claim 1, wherein the dye is substantially uniformly distributed within the set of pores to a depth of at least 8 μm to 10 μm.

6. The housing of claim 1, wherein the aluminum alloy substrate has a thickness of less than 3 mm.

7. The housing of claim 6, wherein the handheld electronic device is a mobile phone.

8. A method comprising:
polishing an aluminum alloy substrate;
anodizing the aluminum alloy substrate to form an anodization layer, wherein the anodization layer has a set of pores with an average diameter of between 10 nm and 40 nm;
dyeing the anodization layer with a black dye to form a dyed anodization layer; and
polishing the dyed anodization layer to a thickness of between 10 μm to 19 μm.

9. The method of claim 8, wherein dyeing of the anodization layer uniformly penetrates black dye to a depth of at least 7 μm from an exterior surface of the anodization layer.

10. The method of claim 8, wherein polishing the aluminum alloy substrate forms a near mirror finish.

11. The method of claim 9, further comprising applying an oleophobic coating to the exterior surface of the dyed anodization layer.

12. The method of claim 11, wherein the oleophobic coating is a fluoropolymer.

13. A method comprising:
media blasting an aluminum alloy substrate;
anodizing the blasted aluminum alloy substrate to form a textured anodization layer, wherein the textured anodization layer has a set of pores with an average diameter of between 10 nm and 40 nm;
dyeing the textured anodization layer with a black dye to form a dyed textured anodization layer; and
wherein dyeing of the textured anodization layer uniformly penetrates black dye to a depth of at least 7 μm from a textured exterior surface of the anodization layer.

14. The method of claim 13, wherein the dyed anodization layer is a thickness between 10 μm and 14 μm.

15. The method of claim 14, further comprising applying an oleophobic coating to the textured exterior surface of the dyed anodization layer.

16. The method of claim 15, wherein the oleophobic coating is a fluoropolymer.

17. The method of claim 13, further comprising polishing the textured dyed anodization layer.

18. A mobile phone comprising:
a housing having a polished exterior surface, and an interior surface configured to receive a plurality of electronic components associated with the mobile phone; and
a cover glass coupled to the housing; wherein
the polished exterior surface abuts an dyed anodization layer; and
wherein the dyed anodization layer has an exterior surface polished to a mirror finish.

19. The mobile phone of claim 18, wherein the dyed anodization layer has a thickness of from 10 μm to 19 μm.

20. The mobile phone of claim 18, wherein the housing is composed of an aluminum alloy substrate having a thickness of less than 3 mm.
